(19) United States
(12) Patent Application Publication
(10) Pub. No.: US 2024/0308384 A1
(43) Pub. Date: Sep. 19, 2024

(54) BATTERY PACK FOR ELECTRIC VEHICLE, AND ELECTRIC VEHICLE COMPRISING SAME

(71) Applicants: AULTON NEW ENERGY AUTOMOBILE TECHNOLOGY CO., LTD., Guangzhou, Guangdong (CN); SHANGHAI DIANBA NEW ENERGY TECHNOLOGY CO., LTD., Shanghai (CN)

(72) Inventors: Jianping Zhang, Shanghai (CN); Danliang Qiu, Shanghai (CN); Meng Liu, Shanghai (CN); Xinrui Yu, Shanghai (CN)

(21) Appl. No.: 18/575,476

(22) PCT Filed: Nov. 30, 2022
(86) PCT No.: PCT/CN2022/135529

§ 371 Date: Dec. 29, 2023

(30) Foreign Application Priority Data
Nov. 30, 2021 (CN) 202111444383.8
Dec. 26, 2021 (CN) 202111606763.7
Dec. 26, 2021 (CN) 202111606781.5
Dec. 31, 2021 (CN) 202111673660.2

(51) Int. Cl. B60L 53/80; B60K 1/04; H01M 50/249; H01M 50/264

(52) U.S. Cl. CPC B60L 53/80; B60K 1/04; H01M 50/249; H01M 50/264; B60K 2001/0438; B60K 2001/0472

(57) ABSTRACT

Disclosed is a battery pack for an electric vehicle and an electric vehicle comprising the same, and the battery pack for an electric vehicle comprises: a cabinet, at least two accommodating cabinets for accommodating the battery modules are provided within the cabinet, and the two accommodating cabinets are arranged at intervals to form a clearance; a locking matching mechanism arranged in the clearance, and a locking point of the locking matching mechanism and the locking mechanism on a vehicle body longitudinal beam is lower than an upper end of the accommodating cabinet. When the battery pack is mounted on the vehicle, it leaves more height space for a battery swapping device, so that the cost, time and difficulty of building the battery swapping station are reduced, the requirements of the construction site to build a station is reduced, and the efficiency of battery swapping is improved.

The present application claims the priority of Chinese patent applications CN2021116736602 filed on Dec. 31, 2021, CN2021116067637 filed on Dec. 26, 2021, CN2021116067815 filed on Dec. 26, 2021 and CN2021114443838 filed on Nov. 30, 2021. The contents of the Chinese patent application are incorporated herein by reference in their entireties.

### TECHNICAL FIELD

The present disclosure relates to the technical field of vehicle battery swapping, in particular to a battery pack for an electric vehicle and an electric vehicle comprising same.

### BACKGROUND

At present, the battery pack for the electric vehicle is heavy in weight and complicated in locking structure, which leads to the great overall thickness of the battery pack. The number of battery packs that can be carried by the battery rack for accommodating the battery packs for the electric vehicle in the battery swapping station for the vehicle depends on the thickness of the battery packs, therefore, such a thicker battery pack is not conducive to increasing the number of battery packs that can be stored and charged on a single charging rack, resulting in a larger volume of the charging rack and the battery swapping station comprising the same, and also resulting in a low energy storage density of the battery swapping station, which is not conducive to setting the battery swapping station in an area where the floor area is highly demanded such as a city.

At present, it is necessary to transport the battery pack to the bottom of the electric vehicle by means of the battery swapping device, lift the battery pack by means of the battery swapping device, and mount the battery pack to the bottom of the electric vehicle. In the case of thick battery pack, in order to make the battery swapping device and the battery pack drive into the bottom of the vehicle, it is necessary to set up a sunken space in the battery swapping station or dig a pit for the battery swapping device to shuttle, or use a lifting apparatus to lift the electric vehicle, which will lead to high cost, long time and high difficulty in building the battery swapping station.

### CONTENT OF THE PRESENT INVENTION

The technical problem to be solved by the present invention is to overcome the defects of high cost, long time and high difficulty in building the battery swapping station in the prior art, caused by that the battery pack is thick, resulting in a large area occupied by the battery swapping station, and the lack of space under the electric vehicle in the height direction for the battery swapping device, which leads to the necessity to set up a sunken space or dig a pit, or lift the electric vehicle, provide a battery pack for an electric vehicle and an electric vehicle comprising the same.

The present invention solves the above technical problems through the following technical solutions:

A battery pack for an electric vehicle, which is mounted on a vehicle body longitudinal beam of the electric vehicle, wherein the battery pack for an electric vehicle comprises:
a cabinet, at least two accommodating cabinets for accommodating the battery modules are provided within the cabinet, and the two accommodating cabinets are arranged at intervals to form a clearance;
a locking matching mechanism, the locking matching mechanism is arranged in the clearance, and a locking point of the locking matching mechanism and the locking mechanism on the vehicle body longitudinal beam is lower than an upper end of the accommodating cabinet.

In the battery pack for an electric vehicle, a clearance is formed between the accommodating cabinets of the cabinet in an interval arrangement way, and a locking matching mechanism is arranged in the clearance, and the locking matching mechanism is used to cooperate with the locking mechanism, to realize mounting the battery pack on the vehicle body longitudinal beam, and at the same time, the thickness of the entire battery pack for an electric vehicle can be reduced, so that the battery swapping station that accommodates the battery pack for an electric vehicle can accommodate a greater number of battery packs and the economical efficiency is improved. When the battery pack for an electric vehicle is mounted on the electric vehicle, more space in the height direction is left for the battery swapping device, so that the height space below the vehicle body longitudinal beam can be fully utilized, so that the battery swapping device can carry out battery swapping from the bottom of the electric vehicle, and it is not necessary to set up a sunken space or dig a pit for the battery swapping device to enter and exit, or lift the electric vehicle to create enough height space for the battery swapping device, so that the cost, time and difficulty of building the battery swapping station will be reduced, and the requirement of the construction site to build a station is reduced, and the efficiency of battery swapping is improved.

Preferably, the locking matching mechanism comprises a locking shaft arranged horizontally, and the locking shaft extends along a width direction of the battery pack.

In the above-mentioned technical solution, the locking shaft is simple in structure and facilitate machining, and can be firmly locked with the locking mechanism.

Preferably, each of the accommodating cabinets comprises:
a cabinet body, a battery cell accommodating groove is arranged within the cabinet body, and the battery module is arranged in the battery cell accommodating groove;
a cabinet cover plate, the cabinet cover plate is detachably connected to a groove opening of the battery cell accommodating groove of the cabinet body and closes the groove opening.

In the above-mentioned structural arrangement, in a way that the cabinet cover plate is opened relative to the cabinet body, it facilitates the disassembly, assembly and maintenance of the battery module relative to the accommodating cabinet.

Preferably, the accommodating cabinet further comprises a sealing member, and the scaling member is arranged around the groove opening of the battery cell accommodating groove and clamped between the cabinet body and the cabinet cover plate.

The above-mentioned structural arrangement improves the sealing effect inside the accommodating cabinet, and prevents external factors from affecting the normal operation of the battery module inside the accommodating cabinet, for example, short circuit of the battery module caused by water flowing into the battery cell accommodating groove.

Preferably, one end or both ends of the locking shaft are respectively connected with the cabinet body or the cabinet cover plate that is adjacent.

In the above-mentioned structural arrangement, the end of the locking shaft is connected with the cabinet body or the cabinet cover plate of the accommodating cabinet, so that the connection between the locking shaft and the accommodating cabinets on both sides is more firm, and the structural strength at the locking shaft is improved, and at the same time, the force received at the locking shaft can be simultaneously transmitted to the accommodating cabinets on both sides, and the action force suffered by the whole battery pack for an electric vehicle is more uniform.

Preferably, the number of the locking shafts is multiple, and a plurality of the locking shafts are arranged along the length direction of the vehicle body longitudinal beam.

In the above-mentioned structural arrangement, the stability and reliability of the battery pack connected to the vehicle body longitudinal beam by means of the locking shaft are improved through the method of increasing connection points between the locking shafts and the lock mechanism.

Preferably, a fixing block is arranged in the clearance, and the both ends of the locking shaft are both connected with the fixing block, and the fixing block is connected with the cabinet body or cabinet cover plate that is adjacent.

The above-mentioned structural arrangement improves the connection reliability of the locking shaft relative to the cabinet body or the cabinet cover plate, and due to the consideration of weight reduction, the plate thickness of the cabinet body and the cabinet cover plate cannot be too thick, and that the locking shaft is transited with the cabinet body or the cabinet cover plate by mean of the fixing box is equivalent to increasing the contact area between the locking shaft and the cabinet body or the cabinet cover plate, under the condition that the plate thickness of the cabinet body and the cabinet cover plate cannot be too thick, in order to realize more reliably connection.

Preferably, the accommodating cavities that are adjacent are connected by a clearance connecting structure and form the clearance;
the clearance connecting structure comprises:
a cover plate, the fixing block is connected with the cabinet body of the accommodating cabinet that is adjacent by means of the cover plate.

In the above-mentioned structural arrangement, the cover plate is arranged in the clearance to realize the connection between the cabinet bodies of adjacent accommodating cabinets, improve the connection strength between adjacent accommodating cabinets, and make the whole cabinet more stable.

Preferably, a locking aperture is arranged on the cover plate at the position corresponding to the locking mechanism, and the locking shaft is located below the locking aperture.

When the battery pack for an electric vehicle is connected to the vehicle body longitudinal beam, the locking aperture can limit the position of the locking mechanism in the horizontal direction, improve the positioning ability of the battery pack for an electric vehicle relative to the vehicle body longitudinal beam, and avoid shaking when the battery pack for an electric vehicle is locked on the electric vehicle, and at the same time, the positioning block can fix both ends of the locking shaft in order to make the connection structure of the locking shaft more stable.

Preferably, the clearance connecting structure further comprises a pair of C-shaped connecting plates, the C-shaped connecting plate extends along the length direction of the vehicle body longitudinal beam, and the opening direction of the pair of C-shaped connecting plates is arranged opposite to each other, and the fixing block is clamped in the C-shaped connecting plates on the corresponding side.

In the above-mentioned structural arrangement, the positioning of a pair of fixing blocks is realized by means of the upper and lower wrapping of the C-shaped connecting plate, which avoids the positioning block from rollover due to the large pulling force from the locking shaft, and makes the connection more reliable, and the stress at the clearance connecting structure is more uniform.

Preferably, the clearance connecting structure further comprises a first supporting plate, and the first supporting plate is arranged between a pair of C-shaped connecting plates, and both ends of the first supporting plate along the width direction of the vehicle body longitudinal beam are respectively connected with a pair of the C-shaped connecting plates.

In the above-mentioned structural arrangement, when the fixing block is suffered too much pulling force from the locking shaft and tends to rollover, a pair of C-shaped connecting plates also have the tendency to rollover close to each other, and at this time, the rollover of the pair of C-shaped connecting plates is prevented by connecting the C-shaped connecting plates on both sides by means of the first supporting plate.

Preferably, the clearance connecting structure further comprises a second supporting plate, the second supporting plate is arranged below the C-shaped connecting plates and is respectively connected with the first supporting plate and the cover plate.

In the above-mentioned structural arrangement, the second supporting plate is additionally arranged below the C-shaped connecting plates, and the second supporting plate is respectively connected with the first supporting plate and the cover plate, which further strengthens the structural strength at the clearance connecting structure, so that the stress at the clearance connecting structure distributes more uniform, and the stress concentration point on the clearance connecting structure can be avoided.

Preferably, the battery pack for an electric vehicle further comprises an ejector rod mechanism for unlocking the locking mechanism, and the ejector rod mechanism is arranged in the clearance, and the ejector rod mechanism comprises an ejector rod, and the ejector rod is vertically arranged and movable along the vertical direction.

In the above-mentioned structural arrangement, when the ejector rod mechanism is driven to push upward in the vertical direction, the purpose of unlocking is realized through contacting with a locking linkage of the locking mechanism located on the vehicle body longitudinal beam of an electric vehicle. By arranging the ejector rod mechanism in the clearance, the ejector rod mechanism can avoid occupying the space of the accommodating cabinet and affecting the number of battery modules, resulting in the decrease of battery capacity.

Preferably, the battery pack for an electric vehicle further comprises a connecting bottom plate, and the connecting bottom plate is arranged in the clearance, and both ends of the connecting bottom plate are respectively connected to the two cabinet bodies;
the ejector rod mechanism further comprises a guiding base, and a guiding aperture is arranged on the guiding base, and the ejector rod is penetrated through the guiding aperture.

In the above-mentioned structural arrangement, the guiding aperture is arranged to realize the purpose of guiding the ejector rod, so that the ejector rod can be kept and moved in the vertical direction.

Preferably, the ejector rod mechanism further comprises a first clastic member, and a limiting part is arranged on the ejector rod, and both ends of the first elastic member are respectively connected with the guiding base and the limiting part, and the first elastic member is adopted for exerting an action force to make the ejector rod move downward to the limiting part.

In the above-mentioned structural arrangement, the automatic reset of the ejector rod is realized by arranging the first elastic member, and the structure is simple and reliable.

Preferably, the first elastic member is sleeved on the ejector rod.

In the above-mentioned structural arrangement, the ejector rod is arranged to position the first clastic member in the horizontal direction.

Preferably, the ejector rod mechanism further comprises:
an ejector base, the ejector base is movably arranged on the connecting bottom plate, and an end of the ejector base close to the ejector rod is provided with a transition groove, and a groove depth direction of the transition groove is vertical, and an end of the ejector rod close to the connecting bottom plate extends into the transition groove and can move in the transition groove along the groove depth direction of the transition groove;
a second elastic member, the ejector base is connected with the ejector rod by means of the second elastic member.

In the above-mentioned structural arrangement, through arranging the ejector base and the second elastic member, when the battery swapping device exerts an action toward the ejector rod to the ejector base, the ejector rod first moves toward the locking mechanism with the ejector base until the locking linkage of locking mechanism touches the ejector rod, and the battery swapping device continues exerting the action force so that the ejector rod gradually penetrates into the transition groove and the second elastic member is gradually compressed, in order to perform a buffering function on the ejector rod, thus avoiding the damage of the ejector rod mechanism caused by rigid interconnection between the ejector rod mechanism and the locking mechanism.

Preferably, a first stair is arranged on the ejector rod, and the second elastic member is sleeved on the ejector rod, and a first end of the second elastic member abuts on the first stair and a second end of the second elastic member abuts on the ejector base.

The above-mentioned structural arrangement realizes the elastic connection of the ejector rod relative to the ejector base.

Preferably, the guiding base is provided with a first limiting aperture, the first limiting aperture is coaxially arranged with the guiding aperture, and a second stair is arranged on the ejector rod, and the ejector rod is penetrated into the first limiting aperture;
the second stair of the ejector rod abuts against the first limiting aperture when the ejector rod mechanism is in an initial state.

The above-mentioned structure arrangement realizes the purpose of limiting the position of the ejector rod in the lifting direction.

Preferably, the guiding base is provided with a second limiting aperture, and a third stair is arranged on the ejector base, and the ejector base is penetrated into the second limiting aperture;
when the ejector rod mechanism is in an initial state, the third stair of the ejector base abuts against the second limiting aperture;

The above-mentioned structure arrangement realizes the purpose of limiting the position of the ejector base in the lifting direction.

Preferably, the part of the ejector base which is below the third stair of the ejector base is provided with a limiting member;
when the ejector rod mechanism is in a limit state, the limiting member abuts against the guiding base.

The above-mentioned structure arrangement can limit the maximum displacement of the upward movement of the ejector base, and prevent the locking mechanism from being damaged by excessive displacement of the ejector rod mechanism.

Preferably, at least a pair of positioning apertures are arranged on the connecting bottom plate, and the positioning apertures are adopted for matching with the positioning pins on the battery swapping device.

The above-mentioned structure arrangement makes full use of the space of the clearance to arrange the positioning structure in order to prevent the positioning aperture and the ejector rod from occupying the space of the accommodating cabinet and affecting the number of the battery modules, resulting in the decrease of the battery capacity.

Preferably, the sectional shape of the positioning aperture is rectangular, and the length directions of the two positioning apertures are different.

In the above-mentioned structural arrangement, two rectangular apertures with different orientations are arranged on both sides of the ejector rod to improve positioning accuracy.

Preferably, the positioning apertures are distributed on both sides of the ejector rod along the length direction of the vehicle body longitudinal beam.

The above-mentioned structural arrangement makes full use of the space of the clearance between the accommodating cabinets, so that the unlocking mechanism of the battery swapping device can ejecting up the ejector rod more accurately when unlocking.

Preferably, the connecting bottom plate is provided with a lightening aperture.

The above-mentioned structural arrangement reduces the weight of the battery pack for an electric vehicle and reduces the manufacturing cost.

Preferably, the battery pack for an electric vehicle further comprises a second electrical connector for docking with the first electrical connector on the vehicle body longitudinal beam, and the second electrical connector is arranged provided at the position on the cabinet corresponding to the first electrical connector, and the second electrical connector is electrically connected with the battery module.

In the above-mentioned structural arrangement, the cables of a plurality of battery modules are concentrated on the second electrical connector to realize interfacing with the first electrical connector on the vehicle body longitudinal beam. The above-mentioned structural arrangement can improve the interfacing reliability by reducing the number of electric connection and interfacing of the battery pack relative to the vehicle body longitudinal beam.

Preferably, the cabinet body further comprises:
a conduit, the conduit is arranged in the clearance and the battery cell accommodating grooves of the adjacent accommodating cabinets are communicated by means of the conduit.

The above-mentioned structural arrangement enables the cables of the battery modules in different accommodating cabinets to be collected in the same accommodating cabinet by means of the conduit in order to facilitate cable wiring and avoid cable exposure.

Preferably, the number of the accommodating cabinets is three, and the three accommodating cabinets are arranged at intervals to form two clearances, and the locking matching mechanism is arranged in two clearances.

The above-mentioned structural arrangement can arrange the locking matching mechanism at different positions of the cabinet body to lock with the locking mechanism of the vehicle body longitudinal beam from different directions to improve the locking effect.

An electric vehicle comprises a vehicle body longitudinal beam and a battery pack for an electric vehicle as described above, and a locking mechanism is arranged on the vehicle body longitudinal beam, and the battery pack for an electric vehicle is detachably connected to the vehicle body longitudinal beam by matching the locking matching mechanism with the locking mechanism.

In the electric vehicle, clearances are formed between the accommodating cabinets of the cabinets, and a locking matching mechanism is provided in the clearance, and the locking matching mechanism is adopted to match with the locking mechanism to realize mounting the battery pack for an electric vehicle on the vehicle body longitudinal beam, and at the same time, the thickness of the entire battery pack for an electric vehicle can be reduced, so that the battery swapping station for accommodating the battery pack for an electric vehicle can accommodate a larger number of battery packs and improve economical efficiency. When the battery pack for an electric vehicle is mounted on the electric vehicle, more space in the height direction is left for the battery swapping device, so that the height space under the vehicle body longitudinal beam can be fully utilized, so that the battery swapping device can carry out battery swapping from the bottom of the electric vehicle, and it is not necessary to set up a sunken space or dig a pit for the battery swapping device to enter and exit, or lift the electric vehicle to create enough height space for the battery swapping device, so that the cost, time and difficulty of building the battery swapping station are reduced, and the requirement of the construction site to build a station is reduced, and the efficiency of battery swapping is improved.

Preferably, the electric vehicle further comprises a vehicle body bracket, and the vehicle body bracket is arranged on the vehicle body longitudinal beam, and the locking mechanism is arranged on the vehicle body bracket.

In the above-mentioned structural arrangement, the battery pack is connected with the vehicle body bracket on the vehicle body longitudinal beam of the electric vehicle, and the connection reliability is higher and it changes less the vehicle body longitudinal beam at the same time.

Preferably, the locking mating mechanism comprises a locking shaft arranged horizontally, and the locking shaft extends along the width direction of the vehicle body longitudinal beam, and the locking mechanism comprises a through groove, through which the locking shaft penetrates.

In the above-mentioned structural arrangement, the locking shaft is arranged in the through groove to realize locking, so that the end of the locking shaft can completely penetrate through the groove and the situation that the locking shaft is detached from the locking mechanism can be reduced, and the connecting stability of the locking shaft relative to the locking mechanism is improved. Furthermore, if the structure of the locking shaft is fixing at both ends, the problem that the locking shaft is detached from the locking mechanism can be completely avoided.

Preferably, the top of the battery pack for an electric vehicle is located below the vehicle body bracket or the vehicle body longitudinal beam.

In the above-mentioned structural arrangement, the battery pack for an electric vehicle does not occupy the upper space of the vehicle body longitudinal beam, so that more space for carrying people and goods can be reserved for the electric vehicle.

The positive progressive effect of the invention is that:

The battery pack for an electric vehicle and the electric vehicle comprising same, a clearance is formed between the accommodating cabinets of the cabinet of the battery pack for an electric vehicle by means of arranging at intervals, and a locking matching mechanism is arranged in the clearance, the locking matching mechanism is adopted to match with the locking mechanism, to realize mounting the battery pack for an electric vehicle on the vehicle body longitudinal beam, while the thickness of the entire battery pack for an electric vehicle can be reduced, so that the battery swapping station for accommodating the battery pack for an electric vehicle can accommodate a larger number of battery packs and improve economical efficiency. When the battery pack for an electric vehicle is mounted on the electric vehicle, more space in the height direction is left for the battery swapping device, so that the height space under the vehicle body longitudinal beam can be fully utilized, so that the battery swapping device can carry out battery swapping from the bottom of the electric vehicle, and it is not necessary to set up a sunken space or dig a pit for the battery swapping device to enter and exit, or lift the electric vehicle to create enough height space for the battery swapping device, so that the cost, time and difficulty of building the battery swapping station are reduced, and the requirement of the construction site to build a station is reduced, and the efficiency of battery swapping is improved.

### BRIEF DESCRIPTION OF THE DRAWINGS

FIG. 1 is a structural schematic diagram of a chassis of an electric vehicle according to an embodiment of the present invention.

FIG. 2 is a schematic diagram of the connection relationship between a battery pack and a vehicle body bracket according to an embodiment of the present invention.

FIG. 3 is a structural schematic diagram of a vehicle body bracket according to an embodiment of the present invention.

FIG. 4 is a structural schematic diagram of a battery pack according to an embodiment of the present invention.

FIG. 5 is a partially structural schematic diagram of a battery pack according to an embodiment of the present invention.

FIG. 6 is a sectional schematic view (I) of the structure of a battery pack according to an embodiment of the present invention.

FIG. 7 is an enlarged partial diagram of Part C of FIG. 6.

FIG. 8 is an enlarged partial diagram of Part D of FIG. 6.

FIG. 9 is a structural schematic diagram of a fixing block according to an embodiment of the present invention.

FIG. 10 is a structural schematic diagram of a cover plate according to an embodiment of the present invention.

FIG. 11 is a structural schematic diagram of a C-shaped connecting plate according to an embodiment of the present invention.

FIG. 12 is a partially sectional schematic view (I) of a clearance connecting structure according to an embodiment of the present invention.

FIG. 13 is a structural schematic diagram of a first supporting plate according to an embodiment of the present invention.

FIG. 14 is a structural schematic diagram of a second supporting plate according to an embodiment of the present invention.

FIG. 15 is a sectional view of a clearance connecting structure according to an embodiment of the present invention.

FIG. 16 is an enlarged partial diagram of Part E of FIG. 15.

FIG. 17 is an enlarged partial diagram of Part F of FIG. 15.

FIG. 18 is a partially sectional view (II) of a clearance connecting structure according to an embodiment of the present invention.

FIG. 19 is a bottom structural schematic diagram of a battery pack according to an embodiment of the present invention.

FIG. 20 is a structural schematic diagram of a battery pack according to an embodiment of the present invention, in which the cabinet cover plate is hidden.

Description of the reference numbers of the drawings:

Electric vehicle 100; battery pack 10; cabinet 1; accommodating cabinet 11; cabinet body 111; battery cell accommodating groove 1111; groove opening 1112; cabinet cover plate 112; sealing member 113; conduit 114; side surface reinforcing structure 115; bottom reinforcing structure 116; weld nut 116a; clearance connecting structure 2; cover plate 21; locking aperture 211; C-shaped connecting plate 22; first supporting plate 23; plugging part 23a; upper surface of the first supporting plate 23b; lower surface of the first supporting plate 23c; second supporting plate 24; rectangular aperture 24a; locking matching mechanism 3; locking shaft 31; fixing block 32; ejector rod mechanism 4; ejector rod 41; limiting part 411; first stair 412; second stair 413; guiding base 42; first limiting aperture 422; second limiting aperture 423; first elastic member 43; ejector base 44; transition groove 441; third stair 442; limiting member 443; second elastic member 45; connecting bottom plate 5; positioning aperture 51; lightening aperture 52; second electrical connector 6; vehicle body longitudinal beam 20; vehicle body bracket 30; locking mechanism 40; first electrical connector 50

### DETAILED DESCRIPTION OF THE PREFERRED EMBODIMENT

The present invention is further described below by way of embodiments, but is not thus limited to the scope of the described embodiments.

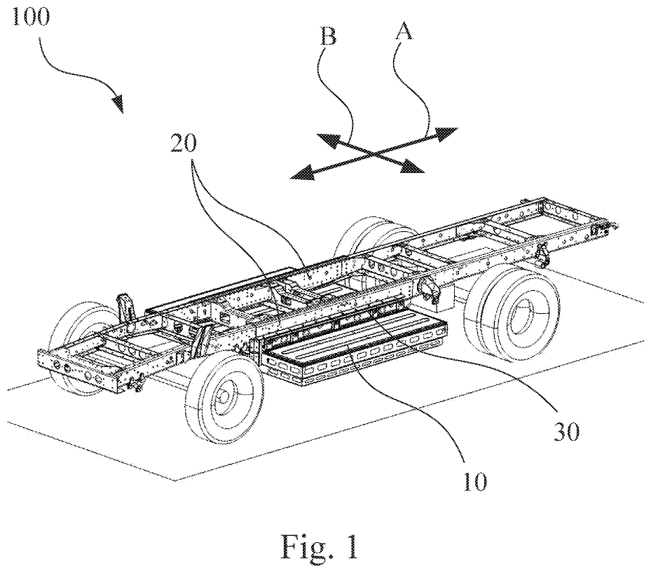

The present invention provides an electric vehicle 100, the structure of the chassis of which is as shown in FIG. 1, and the electric vehicle 100 is provided with two vehicle body longitudinal beams 20 arranged in parallel in the front and rear directions, for connecting the main components of the electric vehicle 100, such as suspension, wheels and so on, and the battery pack for an electric vehicle is also mounted below the two vehicle body longitudinal beams 20, in this embodiment, the electric vehicle 100 is a heavy vehicle or a light vehicle, and of course, it can also be adopted to a vehicle type of a passenger vehicle such as a sedan.

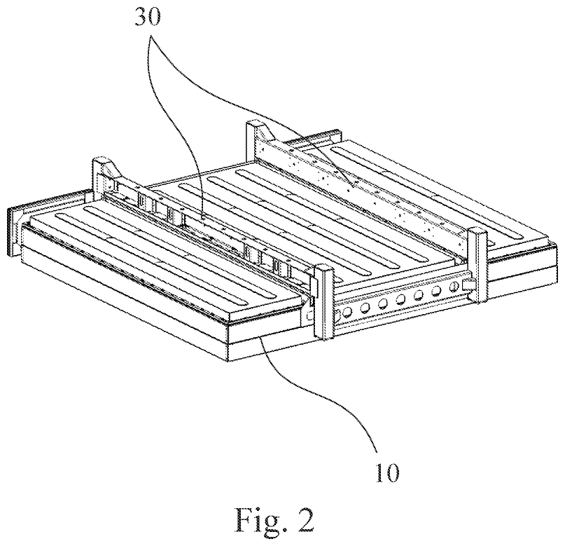

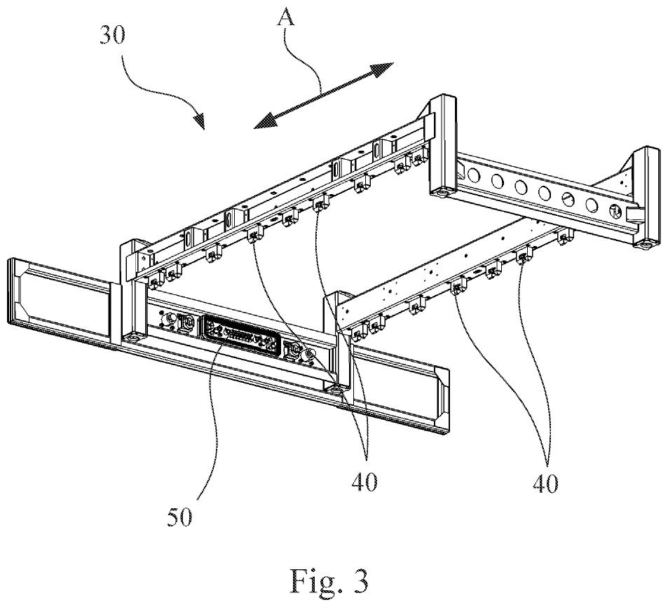

As shown in FIG. 2 and FIG. 3, in the present embodiment, two vehicle body longitudinal beams 20 of the electric vehicle 100 are connected with the vehicle body bracket 30 at the same time, and the vehicle body bracket 30 is a frame structure formed by welding profiles, and each locking mechanism 40 is arranged at the lower surface of the longitudinal beams of vehicle body bracket 30 for locking and connecting with the locking matching mechanism 3 on the battery pack 10, so that the battery pack 10 is connected or disconnected from the vehicle body bracket 30 to achieve the purpose of battery swapping. Wherein, the locking mechanisms 40 are arranged in two rows at the lower surface of the vehicle body bracket 30, to respectively correspond to the two vehicle body longitudinal beams 20, and these locking mechanisms 40 are arranged in sequence along the length direction A of the vehicle body longitudinal beam in order to improve the connection reliability and stability of the battery pack 10 relative to the vehicle body bracket 30 and the vehicle body longitudinal beams 20 by means of multi-point connection.

At the same time, a first electrical connector 50 is arranged at the end position of the vehicle body bracket 30 for docking with a second electrical connector 6 on the side surface of the battery pack 10, in order to realize the electrical connection relative to the battery pack 10 and meet the requirement of supplying power to the electric vehicle 100 when the battery pack 10 is mounted on the vehicle body bracket 30.

Wherein, as shown in FIG. 2, the battery pack 10 is arranged below the vehicle body bracket 30 so that the battery swapping device (not shown in the figure) can be connected with the battery pack 10 from below, and lock or unlock the battery pack 10 relative to the locking mechanism 40 of the vehicle body bracket 30, to realize taking, placing and transferring of the battery pack 10.

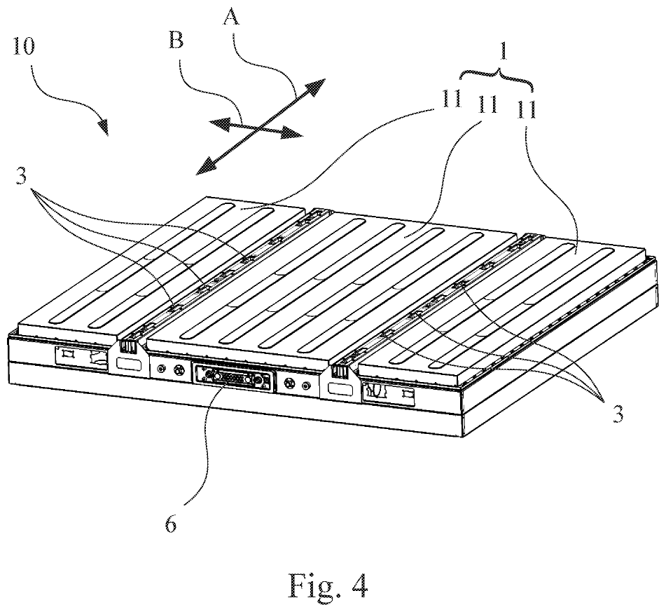

The specific structure of the battery pack 10 is as shown in FIG. 4, which comprises a cabinet 1, a locking matching mechanism 3 and a second electrical connector 6. Wherein, the second electrical connector 6 is arranged at a middle position of the side surface of the cabinet 1, to correspond to the first electrical connector 50 of the vehicle body bracket 30. The cabinet 1 is composed of three accommodating cabinets 11 for accommodating battery modules, the three accommodating cabinets 11 are arranged sequentially at intervals along the width direction B of the vehicle body longitudinal beam in order to form a clearance between two adjacent accommodating cabinets 11, and the locking matching mechanisms 3 are distributed in the two clearances and are arranged corresponding to the positions of each locking mechanisms 40 of the vehicle body bracket 30.

In the battery pack for an electric vehicle, clearances are formed between the accommodating cabinets 11 of the cabinet 1 in an interval arrangement way, and the locking matching mechanism 3 is arranged in the clearances, so that the thickness of the entire battery pack for an electric vehicle can be reduced, so that the battery swapping station that accommodates the battery pack for an electric vehicle can accommodate a greater number of battery packs 10 and improve economical efficiency. When the battery pack for an electric vehicle is mounted on the electric vehicle 100, more space in the height direction is left for the battery swapping device, so that the height space below the vehicle body longitudinal beam 20 can be fully utilized, so that the battery swapping device can carry out battery swapping from the bottom of the electric vehicle, and it is not necessary to set up a sunken space in the battery swapping station or dig a pit for the battery swapping device to enter and exit, or lift the electric vehicle to create enough height space for the battery swapping device, so that the cost, time and difficulty of building the battery swapping station will be reduced, and the requirement of the construction site to build a station is reduced, and the efficiency of battery swapping is improved.

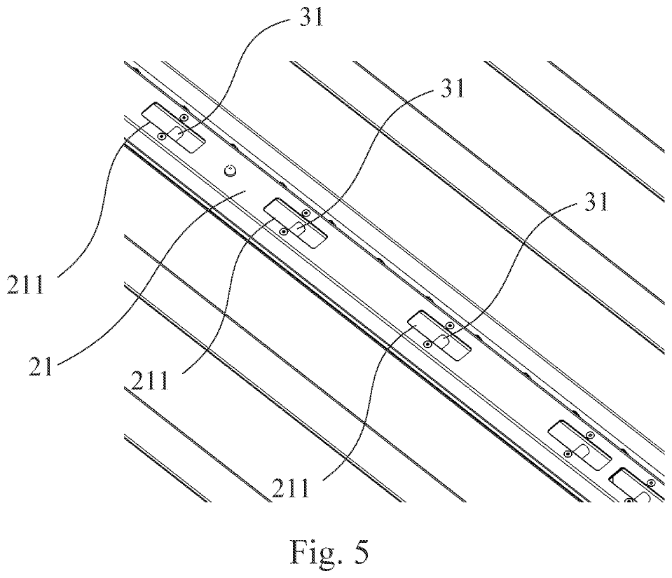

As shown in FIG. 5, the locking matching mechanism 3 comprises a locking shaft 31 arranged horizontally, the both ends of the locking shaft 31 are fixedly connected to the accommodating cabinets 11 on the adjacent side, and the locking shaft 31 extends along the width direction of the battery pack 10 (the width direction B of the vehicle body longitudinal beam) and the position of the locking shaft 31 is lower than the upper end of the accommodating cabinet 11. The locking mechanism 40 located on the vehicle body bracket 30 is provided with a horizontally through groove arranged corresponding to the locking shaft 31, and the through groove is adopted for the locking shaft 31 to penetrate through to realize the locking of the locking shaft 31 relative to the locking mechanism 40, wherein, the locking is achieved by accommodating the locking shaft 31 by means of the through groove, so that both ends of the locking shaft 31 can be fixed, in order to avoid the situation that the locking shaft 31 being a cantilever structure, so that the connection stability of the locking shaft 31 relative to the locking mechanism 40 can be improved.

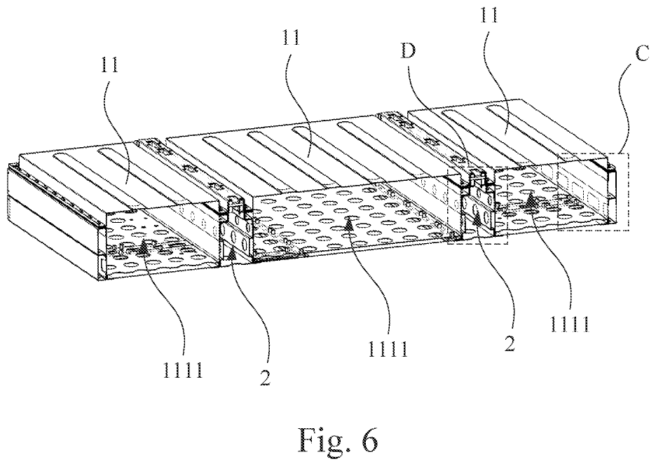

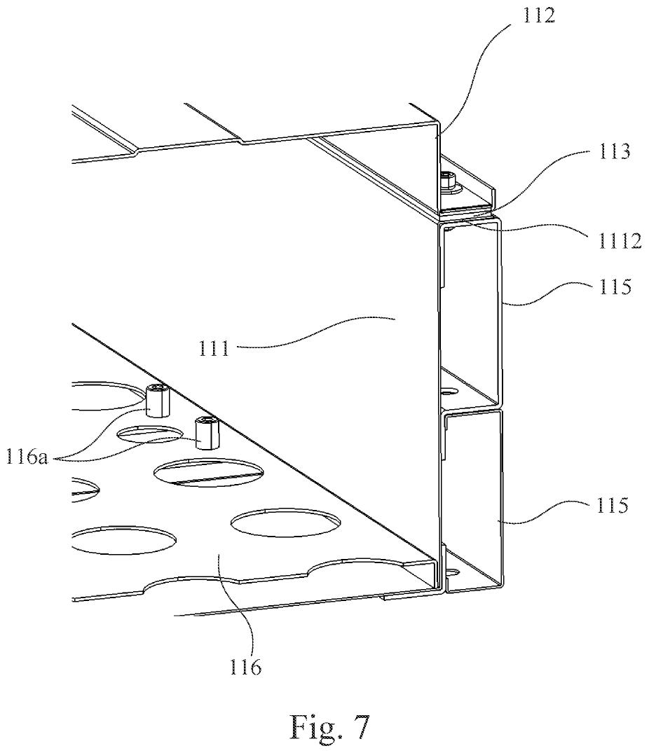

As shown in FIG. 6 and FIG. 7, for the cabinet 1 of the battery pack 10, each of accommodating cabinets 11 comprises a cabinet body 111 and a cabinet cover plate 112. Wherein, a battery cell accommodating groove 1111 is arranged in the cabinet body 111, and a battery module is arranged in the battery cell accommodating groove 1111, and the size of the battery module can be smaller than the battery cell accommodating groove 1111 so that a plurality of battery modules can be accommodated at the same time in a single accommodating cabinet 11. The cabinet cover plate 112 is connected to the groove opening 1112 of the battery cell accommodating groove 1111 of the cabinet body 111 by means of bolted connection and covers and closes the whole groove 1112. Through this structural solution, the cabinet cover plate 112 is arranged to be open relative to the cabinet body 111, which facilitates the disassembly, assembly and maintenance of the battery module relative to the accommodating cabinet 111, and at the same time, the cabinet cover plate 112 closes the cabinet body 111 in order to protect the internal battery module from the influence of external factors.

At the same time, to improve the sealing effect, the accommodating cabinet 11 further comprises a scaling member 113, and the sealing member 113 is around the groove opening 1112 of the battery cell accommodating groove 1111 and clamped between the groove opening 1112 of the cabinet body 111 and the cabinet cover plate 112 (see FIG. 7). In this embodiment, the scaling member 113 is foamed silicone pad in order to achieve the purpose of reliable sealing, and of course, in other embodiments, other sealing materials may be adopted to realize scaling.

In this embodiment, the number of locking shafts 31 is multiple, and these locking shafts 31 are arranged along the length direction A of the vehicle body longitudinal beam 20, and both ends of the locking shafts 31 are respectively connected with the cabinet bodies on the adjacent side, so that the height of the locking shafts 31being lower than the upper end of the cabinet body is achieved. In other embodiments, both ends of the locking shaft 31 can also be fixedly connected with the cabinet covers on the adjacent sides; it is possible that only one end of the locking shaft 31 is a fixed end and is connected with the cabinet body or the cabinet cover plate on one side, and the other end of the locking shaft 31 is a free end, and the locking function with the locking mechanism can also be realized, which will not be described repeatedly here.

In addition, as shown in FIG. 7, two upper and lower sets of side surface reinforcing structures 115 are welded to the circumferential surface of the cabinet body 111, and the side surface reinforcing structures 115 are formed by bending plates and are fixed to the circumferential surface of the cabinet body 111 by welding, to strengthen the circumferential strength of the cabinet body 111 and protect the cabinet body 111 better. At the same time, a bottom reinforcing structure 116 is also welded to the bottom surface of the cabinet body 111 for carrying the battery module, and for strengthening the strength of the bottom surface of the cabinet body 111, to prevent the bottom surface of the cabinet body 111 from forming a depression under a large load-bearing condition. Lightening apertures are distributed on the surface of the bottom reinforcing structure 116, to achieve purposes of reducing weight and lightening. The upper surface of the bottom reinforcing structure 116 is also welded with weld nuts 116a for threaded connection and fixing of the battery module.

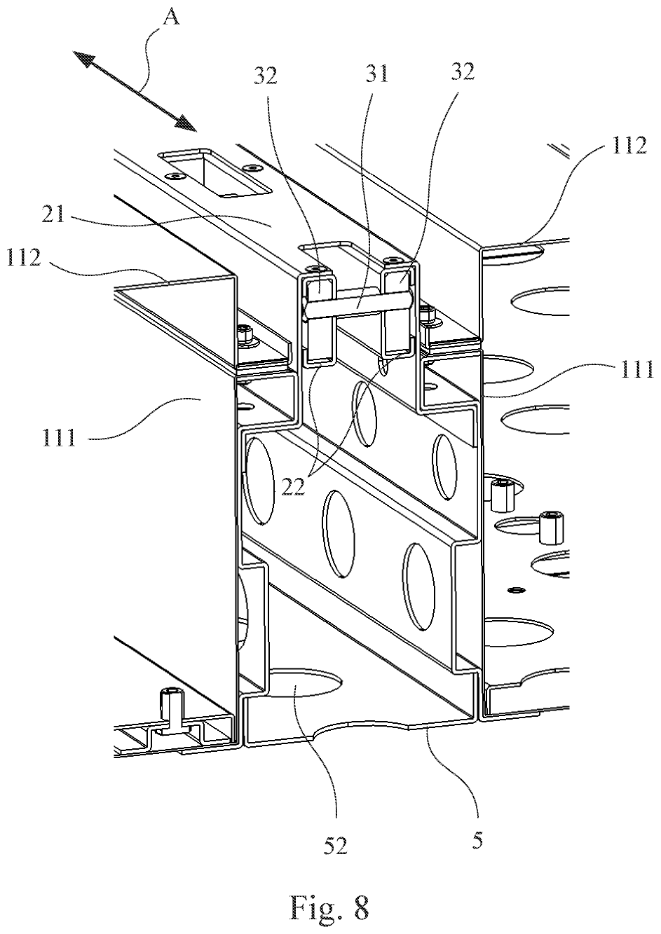

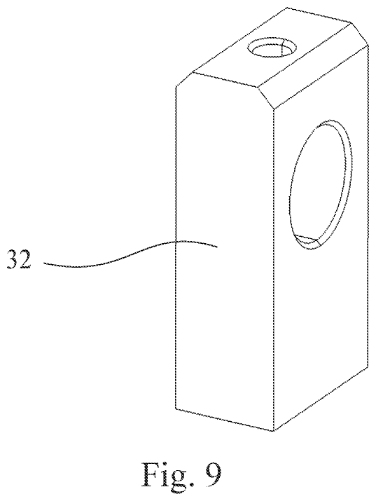

As shown in FIG. 8, in the present embodiment, in the clearance between the two accommodating cabinets 11, in order to make the locking shaft 31 more firmly connected in the clearance, both ends of the locking shaft 31 are respectively connected to the fixing block 32, and the end of the locking shaft 31 is fixed in the fixing block 32 by mounting fastening screws at the top end of the fixing block 32, and the structure of the fixing block 32 is as shown in FIG. 9, the cabinet bodies 111 of the accommodating cabinets 11 on both sides are connected to the locking shaft 31 by means of the fixing block 32. This connection solution can improve the connection reliability of the locking shaft 31 relative to the cabinet body 111, the plate thickness of the cabinet body 111 cannot be too thick in consideration of reducing weight, and the locking shaft 31 is transited and connected with the cabinet body 111 and the cabinet cover plate 112 by means of the fixing block 32, and in the case that the plate thickness of the cabinet body 111 cannot be too thick, the area of contact of connecting with the locking shaft 31 is increased by means of the fixing block 32, in order to realize more reliably connection. Of course, in other embodiments, the locking shaft 31 may also be fixed to the cabinet cover plate 112 by mean of the fixing block 32.

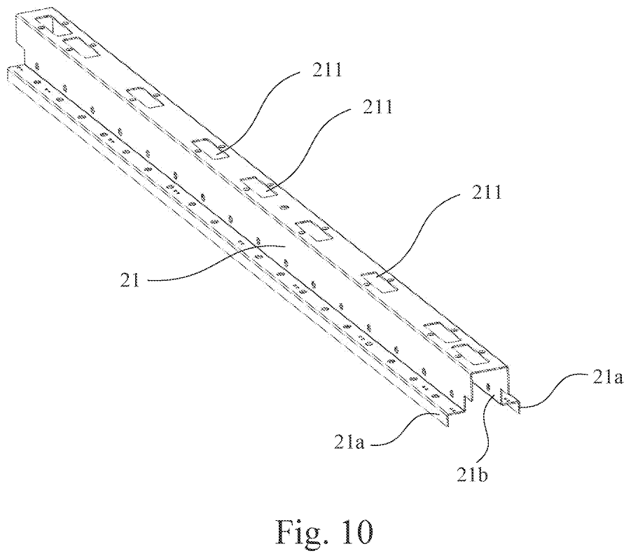

At the same time, the two accommodating cabinets 11 are reliably connected by means of a clearance connecting structure 2 between two accommodating cabinets 11 and the clearance connecting structure is adopted for fixing the locking shaft 31, and the adjacent accommodation cabinets are connected by a clearance connecting structure and form the above-mentioned clearance, and the clearance connecting structure 2 comprises a cover plate 21, and the structure of the cover plate 21 is as shown in FIG. 10, and the fixing block 32 is connected with the cabinet body 111 of the adjacent accommodation cabinet 11 by means of the cover plate 21, and the cover plate 21 is arranged in the clearance to realize the connection between the cabinet bodies 111 of the adjacent accommodating cabinets 11, and the connection between the adjacent accommodating cabinets 11 is improved so that the whole cabinet 1 is more stable. And the cover plate 21 covers above of the locking shaft 31, and the cover plate 21 is provided with a rectangular locking aperture 211, and the locking aperture 211 is formed on the cover plate 21 corresponding to the locking shaft 31 for the locking mechanism 40 to extend into. The cover plate 21 is attached and welded to the reinforcing structure on the side surfaces of the cabinet body 111 on both sides by means of the end portions 21a on both sides to realize the reliable connection between the locking shaft 31, the fixing block 32, the cover plate 21 and the cabinet body 111, in order to improve the structural strength of the locking shaft 31 by connecting the cabinet body 111 of the accommodating cabinet 11 or the cabinet cover plate 112 to the end portions of the locking shaft 31, so that the battery pack 10 is connected to the vehicle body longitudinal beam 20 better by means of the locking shaft 31.

In this structural arrangement solution, when the battery pack for an electric vehicle is connected to the vehicle body bracket 30 on the vehicle body longitudinal beam 20, the locking aperture 211 can limit the position of the locking mechanism 40, improve the positioning ability of the battery pack for an electric vehicle relative to the vehicle body longitudinal beam 20 of the vehicle, avoid shaking when the battery pack for an electric vehicle is locked on the electric vehicle 100, and at the same time, fixation of both ends of the locking shaft 31 is realized by the positioning block, so that the connection structure of the locking shaft 31 is more stable.

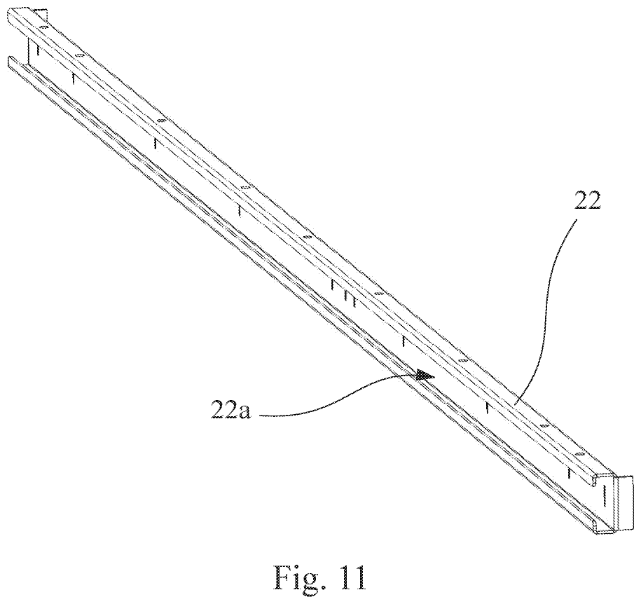

As shown in FIG. 8, a pair of C-shaped connecting plates 22 is further arranged in the clearance connecting structure 2 in order to prevent rollover due to excessive force on the fixing block, and the structure of the C-shaped connecting plates 22 is as shown in FIG. 11. The two C-shaped connecting plates 22 extend along the longitudinal direction A of the vehicle body longitudinal beam and the openings 22a of the two C-shaped connecting plates 22 are arranged opposite to each other and the fixing blocks 32 are clamped in the C-shaped connecting plate 22 on the corresponding side, and the end of the locking shaft 31 protrudes from the opening 22a of the C-shaped connecting plate 22 after penetrating through the fixing blocks 32. This solution of realizing the connection relative to the fixing blocks 32 by the upper and lower wrapping for the C-shaped connecting plate 22 makes the connection between the fixing blocks 32 more reliable and the force transmission of each locking shaft 31 more uniform.

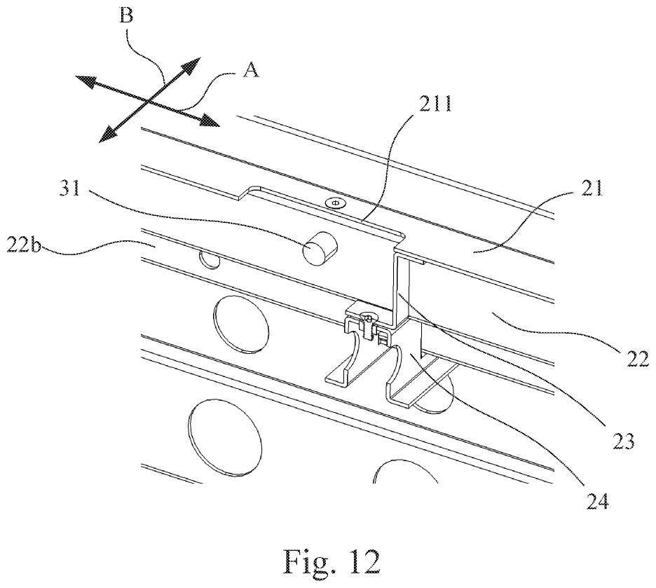

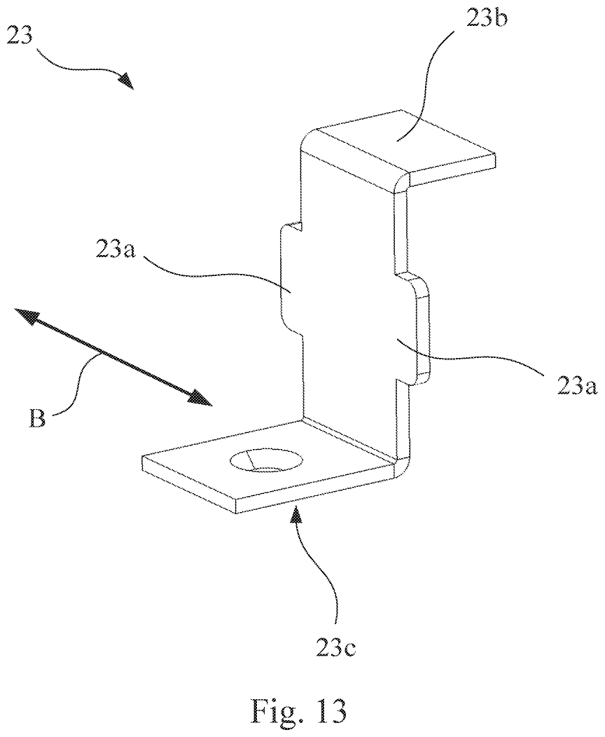

As shown in FIG. 12, in the partial sectional view of the battery pack 10 in the extending direction of the clearance (i.e. the length direction A of the vehicle body longitudinal beam), it can be seen that the clearance connecting structure 2 further comprises a first supporting plate 23 and a second supporting plate 24, the forementioned two supporting plates are adopted to strengthen the structural strength of the cover plate 21 and the C-shaped connecting plate 22 in the clearance connecting structure 2, respectively, so that the connection of the locking shaft 31 relative to the cabinet body 111 of the accommodating cabinet 11 is more stable and reliable.

Wherein, the first supporting plate 23 is arranged between two C-shaped connecting plate 22 arranged in pairs, and the structure of the first supporting plate 23 is as shown in FIG. 13, inserting portions 23a are arranged respectively at both ends of the first support plate 23 along the width direction B of the vehicle body longitudinal beam for inserting and positioning the two C-shaped connecting plates 22 and realizing reliable connection by welding, so that the two C-shaped connecting plate 22 can be directly connected by means of the first support plate 23. In this embodiment, a plurality of first supporting plates 23 are arranged in the extending direction of the C-shaped connecting plate 22 (i.e. the length direction A of the vehicle body longitudinal beam), so that the integration of the two C-shaped connecting plates 22 is better and the C-shaped connecting plate 22 is not caused to rollover due to excessive force on the fixing block. Furthermore, the upper surface of the first supporting plate 23b can be attached and welded to the cover plate 21, and the lower surface of the first supporting plate 23c can be fixed in a nut on the top of the second supporting plate 24 by screws.

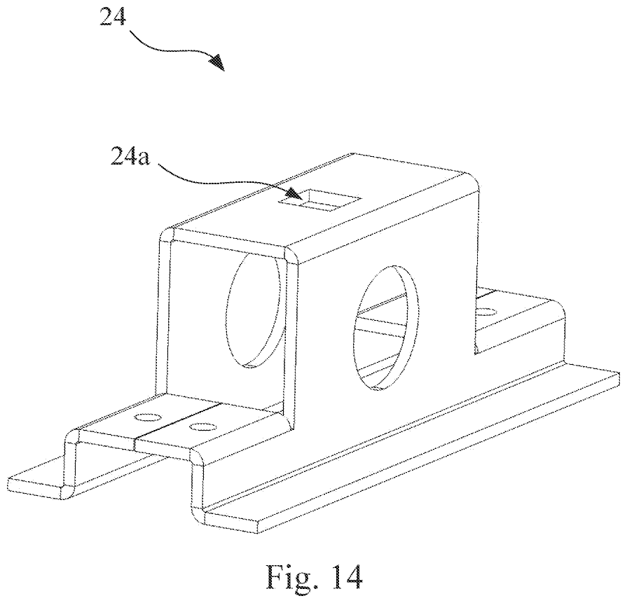

The structure of the second supporting plate 24 is as shown in FIG. 14, the top of the second supporting plate 24 is provided with a rectangular aperture 24a for accommodating and welding a square nut for connection with the first supporting plate 23. As shown in FIG. 12, the second supporting plate 24 is arranged below the C-shaped connecting plate 22 and is respectively connected by welding to the first supporting plate 23and the inner surface 21b of and the cover plate 21. With this structural arrangement, the second supporting plate 24 connects the first supporting plate 23 and the cover plate 21 below the C-shaped connecting plate 22 to further strengthen the structural strength at the clearance connecting structure, so that the force exerted to the locking shaft 31 when kept locking to the locking mechanism 40 can be uniformly distributed, to avoid the occurrence of stress concentration points on the clearance connecting structure 2.

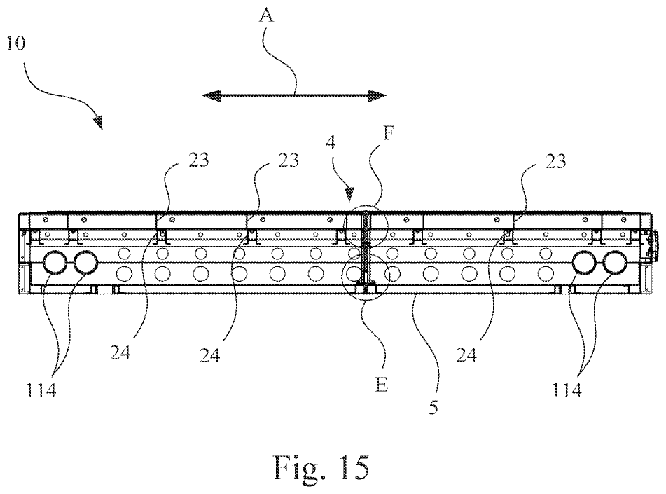

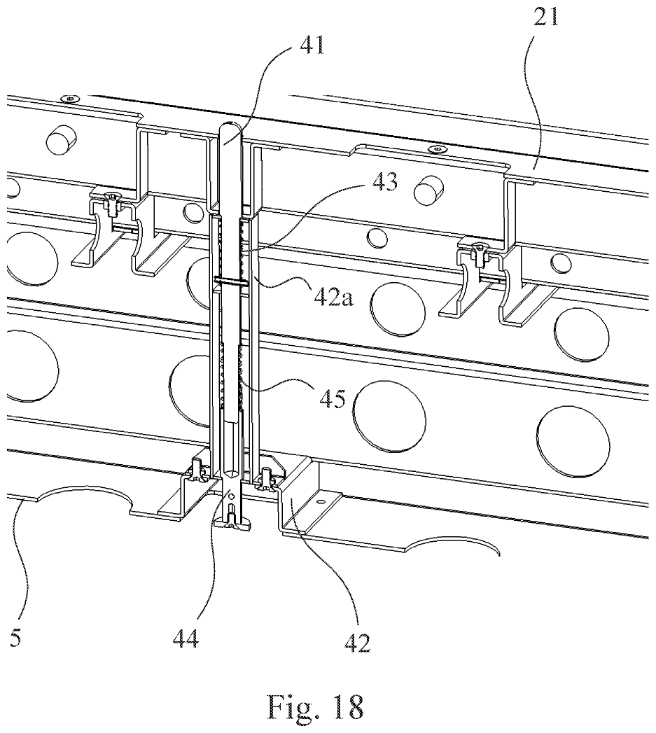

As shown in FIGS. 15-18, in the sectional view of the battery pack 10 in the extending direction of the clearance (i.e. the length direction A of the vehicle body longitudinal beam), it can be seen that the battery pack 10 further comprises an ejector rod mechanism 4 for unlocking the locking mechanism 40 on the vehicle body bracket 30, the ejector rod mechanism 4 is arranged in the vertical direction in the clearance of the battery pack 10, and the ejector rod mechanism 4 comprises an ejector rod 41 extending in the vertical direction, and the ejector rod 41 can move in the vertical direction. In a specific unlocking solution, the unlocking mechanism on the battery swapping device carrying the battery pack 10 ejects the ejector rod 41 upward, and the ejector rod 41 is driven to move upward, when the ejector rod mechanism 4 is driven to be ejected upward in the vertical direction, the locking mechanism 40 is driven to unlock by touching a locking linkage of the locking mechanism on the vehicle body bracket 30 of the electric vehicle 100, in order to achieve the purpose of unlocking. In this embodiment, the ejector rod mechanism 4 is arranged in the clearance to prevent the ejector rod 41 from occupying the space of the accommodating cabinet 11 and affecting the number of battery modules, resulting in a decrease in battery capacity.

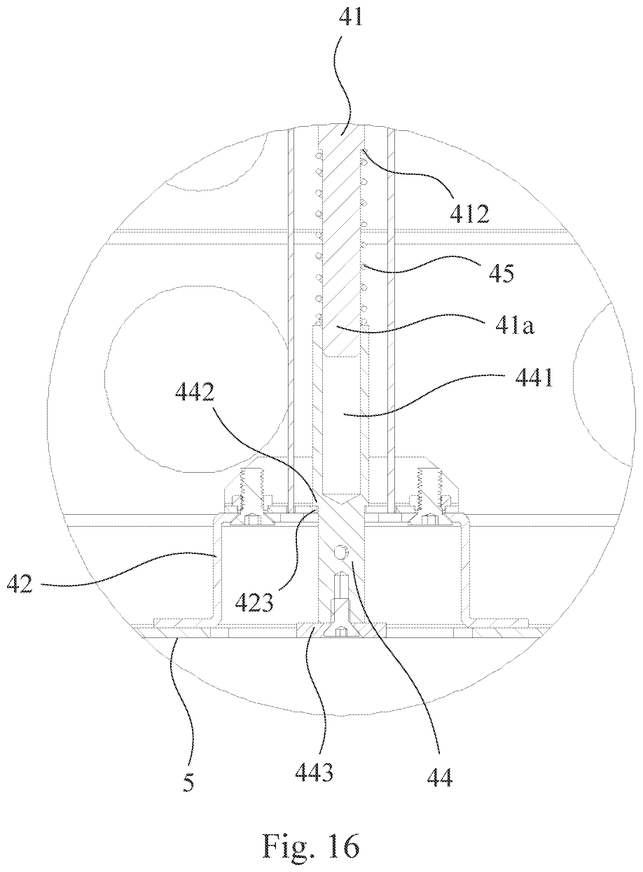

Specifically, as shown in FIG. 16, the battery pack for an electric vehicle further comprises a connecting bottom plate 5, and the connecting bottom plate 5 is arranged in the clearance and both ends of the connecting bottom plate 5 are respectively connected to the two cabinet bodies 111. The ejector rod mechanism 4 further comprises a guiding base 42 welded on the upper surface of the connecting bottom plate 5, and a guiding aperture is provided on the guiding base 42. The ejector rod 41 penetrates through the guiding aperture, so that the guiding aperture is adopted to limit the ejector rod 41, and this structural arrangement can realize the purpose of guiding the ejector rod 41 so that the ejector rod 41 keeps moving in the vertical direction.

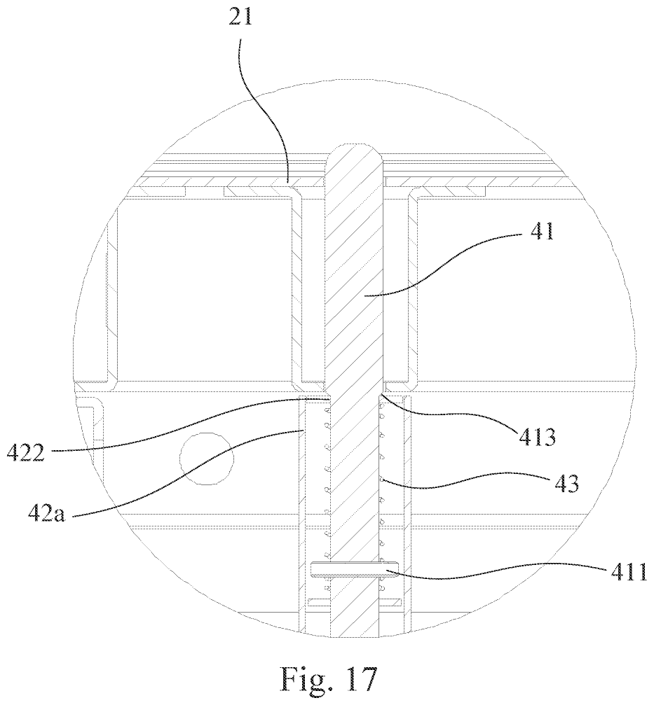

As shown in FIG. 17, the ejector rod mechanism 4 further comprises a first elastic member 43, and a limiting part 411 is arranged on the ejector rod 41, and both ends of the first clastic member 43 are respectively connected to the top end 42a of the guiding base 42 and the limiting part 411 of the ejector rod 41, and the first clastic member 43 is adopted for exerting an action force to the limiting part 411 to drive the ejector rod 41 to move downward. Automatic reset of the ejector rod 41 is realized by arranging the first elastic member 43. In this embodiment, the limiting part 411 on the ejector rod 41 is a pin shaft penetrated on the side surface of the ejector rod 41, and the first clastic member 43 is a spring sleeved on the ejector rod, and by setting the pin shaft, a protruding structure is formed on the side surface of the ejector rod 41, so that the protruding structure is penetrated in the clearance between two turns of the spring to realize positioning of the first elastic member 43.

Besides, in order to prevent the ejector rod mechanism being excessively ejected so that the ejector rod mechanism or the locking mechanism is damaged, the ejector rod mechanism 4 further comprises an ejector base 44, the ejector base 44 is movably arranged on the connecting bottom plate 5 and the end of the ejector base 44 close to the ejector rod 41 is provided with a transition groove 441, and the depth direction of the transition groove 441 is vertical and the opening direction is toward the ejector rod 41, and the lower end 41a of the ejector rod 41 close to the connecting bottom plate 5 extends into the transition groove 441 and can move up and down in the transition groove 441 along the depth direction of the transition groove 441.

Elastic connection between the ejector base 44 and the ejector rod 41 is achieved by means of a second elastic member 45, and the position that the second elastic member 45 is arranged relative to the ejector base 44 and the ejector rod 41 as shown in FIG. 16, and the second elastic member 45 is a coiled spring sheathed on the outer surface of the lower end 41a of the ejector rod 41. The cushioning function can be performed by providing the ejector base 44 and the second clastic member 45. In other embodiments, the second elastic member 45 may also be provided inside the transition groove 441 for the purpose of elastically connecting the ejector base 44 and the ejector rod 41.

Wherein, a first stair 412 is arranged on the ejector rod 41, and the second elastic member 45 is sleeved on the ejector rod 41, and the upper end of the second elastic member 45 abuts against the first stair 412, and the lower end of the second elastic member 45 abuts against the top end of the ejector base 44.

As shown in FIG. 17, the guiding aperture on the guiding base 42 comprises a first limiting aperture 422 located at the top end 42a, and the first limiting aperture 422 is coaxially arranged with the guiding aperture located at the lower side of the guiding base 42, and the second stair 413 matched with the size of the first limiting aperture 422 is arranged on the ejector rod 41, and in the situation that the ejector rod 41 penetrates through the first limiting aperture 422, when the ejector rod mechanism 4 is in the initial state, the second stair 413 of the ejector rod 41 can abut against the first limiting aperture 422 to limit the downward position of the ejector rod 41 in the lifting direction by the guiding base 42.

In addition, the guiding aperture of the guiding base 42 further comprises a second limiting aperture 423 located on the lower side, and a third stair 442 is arranged on the ejector base 44, and in the situation that the ejector base 44 penetrates through the second limiting aperture 423, when the ejector rod mechanism 4 is in the initial state, the ejector base 44 abuts against the second limiting aperture 423 by means of the third stair 442 to limit the position of the ejector base 44 in the lifting direction.

Besides, it is more preferable that a limiting member 443 is arranged on the lower part of the third stair 442 of the ejector base 44, and when the ejector rod mechanism moving upward and is in the limit state, the limiting member 443 can abut against the guiding base 42 to limit the maximum displacement of the upward movement of the ejector base 44. In this embodiment, the limiting member 443 is an annular flange extending outward from the lower end of the ejector base 44 in the circumferential direction.

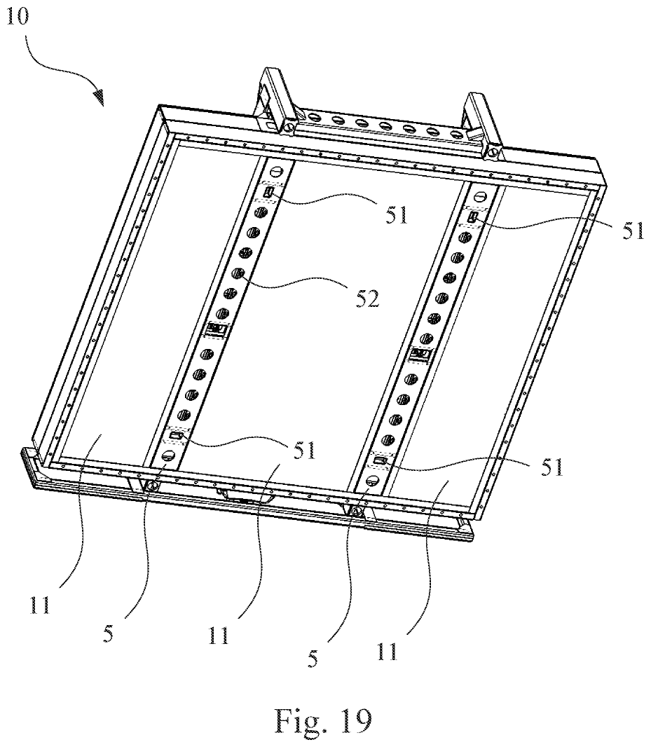

As shown in FIG. 19, each connecting bottom plate 5 is provided with a pair of positioning apertures 51, and the position of the positioning apertures 51 relative to the connecting bottom plate 5 and the accommodating cabinet 11 is as shown in FIG. 19, and the positioning apertures 51 are adopted for matching with the positioning pins on the battery swapping device. By providing positioning apertures 51 at a position where the connection bottom plate 5 is located in order to make full utilization of the space of the clearance to provide the positioning structure, in order to prevent the positioning apertures 51 and the ejector rod 41 from occupying the space of the accommodating cabinet 11 and affecting the number of battery modules and causing the battery capacity to decrease.

Wherein, the sectional shape of the positioning aperture 51 is rectangular, and the length directions of the two positioning apertures 51 on each connecting bottom plate 5 are perpendicular to each other. Positioning accuracy is improved by arranging two rectangular apertures with different orientations on both sides of the ejector rod 41. In this embodiment, the two positioning apertures 51 on each connecting bottom plate 5 are distributed on both sides of the ejector rod 41 along the length direction A of the vehicle body longitudinal beam, in order to make full utilization of the clearance space between adjacent accommodating cabinets 11, and before unlocking, the battery swapping device is precisely aligned with the battery pack, so that when unlocking, the unlocking mechanism of the battery swapping device can eject up the ejector rod 41 more accurately.

In other specific implementations, the shape of the positioning aperture 51 is not limited to this example, and can also be circular, oval, triangular, pentagonal, etc, and when the positioning apertures 51 are rectangular apertures, the included angle of the two positioning apertures 51 in lengths direction is not necessarily 90°, and it can also be other included angles that make the length directions of the two positioning apertures 51 non-parallel, which will not be described repeatedly here.

Besides, as shown in FIG. 8 and FIG. 19, lightening apertures 52 are arranged in the connecting bottom plate 5 to achieve lightening purposes.

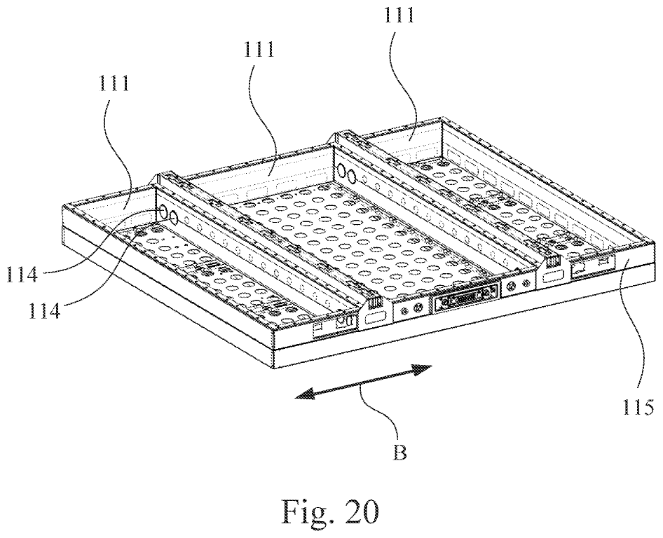

As shown in FIG. 15 and FIG. 20, the cabinet 1 further comprises a conduit 114, the conduit 114 is arranged in a clearance and penetrates through the cabinet bodies 111 of two adjacent accommodating cabinets 11, so that battery cell accommodating grooves 1111 between the accommodating cabinets 11 can be communicated through the conduit 114, so that the cables of battery modules in different accommodating cabinets 11 can be collected in the same accommodating cabinet 11 through the conduit 114, in order to facilitate cable wiring and avoid cable exposure.

Additionally, as shown in FIG. 20, further, the side surface reinforcing structure 115 fixed on the side surface of the cabinet body 111 is an overall structure, that is, the side surface reinforcing structure 115 extends along the width direction B of the vehicle body longitudinal beam and is connected to the side surfaces of the three cabinet bodies 111 at the same time to achieve the overall reinforcement of the cabinet body 1, and the structural consistency among the three accommodating cabinets 11 is better.

Of course, in other embodiments, the number of accommodating cabinets 11 may also be two or more than four.

When the number of the accommodating cabinets 11 is two, a clearance is formed for arranging the locking matching mechanism 3. When the number of the accommodating cabinets 11 is four, three clearances are formed, and the locking matching mechanism 3 may be arranged in two of the three clearances or in all of the three clearances.

In other specific embodiments, the locking mechanism 40 may be provided directly on the lower surface of the vehicle body longitudinal beam 20 without providing the vehicle body bracket, and when the battery pack for an electric vehicle is connected to the vehicle body longitudinal beam 20, the battery pack for an electric vehicle is located below the vehicle body longitudinal beam 20, which will not be described repeatedly here.

In other specific solutions, the locking mechanism and the locking matching mechanism are not limited to the present example, but may also be T-type locking or thread locking, which will be briefly described below.

The first type: T-type locking

The locking mechanism comprises a locking base, and the locking base is provided with a first opening extending in the vertical direction, and a first thread part is arranged in the first opening, and the first thread part is an internal thread, and the locking matching mechanism comprises a mounting base and an unlocking rod, and the mounting base is provided with a second opening extending in the vertical direction, and the unlocking rod is vertically arranged in the second opening, and the unlocking rod can move in the vertical direction relative to the mounting seat, and a second thread part matched with the first thread part is arranged on the unlocking rod, and the second thread part can be meshed with the first thread part to realize locking and unlocking of the locking mechanism and the locking matching mechanism.

The second type: thread locking

The locking mechanism comprises a locking base, and the locking base is provided with a first opening extending in the vertical direction, and a limiting part is arranged in the first opening, and the first opening is a square opening and the upper part of the first opening forms the limiting part, and the locking matching mechanism comprises an unlocking rod, and the upper end of the unlocking rod is provided with a backstopping part, and the backstopping part comprises a locking rod extending along the horizontal direction, the locking rod is a cylindrical object and is horizontally arranged on the top of the unlocking rod, and the locking rod and the unlocking rod jointly form a T-shaped structure.

When the locking rod is at the first angle, the locking rod can penetrate through the first opening and enter into the limiting part of the locking base, and when the locking rod is rotated to the second angle, the locking rod can be restricted in the limiting part of the locking base so that the locking mechanism and the locking matching mechanism are relatively fixed.

In the above-mentioned embodiment, the height space below the vehicle body longitudinal beam 20 is fully utilized, and when the battery swapping device disassembles the battery pack, the no-load battery swapping device can directly enter the space below the battery pack 10 without interfacing with the bottom of the electric vehicle 100; and when the battery swapping device mounts the battery pack 10, the battery swapping device carrying the battery pack 10 can enter below the vehicle body longitudinal beam 20 and carry out battery swapping without interfacing with the bottom of the electric vehicle 100. In the whole process, it is not necessary to lift the vehicle body or to set up a sunken space or dig a pit for the battery swapping device to enter and exit, so that the cost, time and difficulty of building the battery swapping station are reduced, and the requirement of the construction site to build a station is lowered, and the efficiency of battery swapping is improved.

While specific embodiments of the invention have been described above, it should be understood by a person skilled in the art that these are illustrative only that various changes or modifications may be made to these embodiments without departing from the principles and essence of the invention. Therefore, the scope of protection of the invention is therefore defined by the appended claims

1. A battery pack for an electric vehicle, which is mounted on a vehicle body longitudinal beam of the electric vehicle, wherein, the battery pack for an electric vehicle comprises:
a cabinet, at least two accommodating cabinets for accommodating battery modules are provided within the cabinet, and the two accommodating cabinets are arranged at intervals to form a clearance;
a locking matching mechanism, the locking matching mechanism is arranged in the clearance, and a locking point of the locking matching mechanism and the locking mechanism on the vehicle body longitudinal beam is lower than an upper end of the accommodating cabinet.

2. The battery pack for an electric vehicle according to claim 1, wherein, the locking matching mechanism comprises a locking shaft arranged horizontally, and the locking shaft extends along a width direction of the battery pack.

3. The battery pack for an electric vehicle according to claim 2, wherein, each of the accommodating cabinets comprises:
a cabinet body, a battery cell accommodating groove is provided within the cabinet body, and the battery module is arranged in the battery cell accommodating groove;
a cabinet cover plate, the cabinet cover plate is detachably connected to a groove opening of the battery cell accommodating groove of the cabinet body and closes the groove opening.

4. The battery pack for an electric vehicle according to claim 3, wherein, the accommodating cabinet further comprises a sealing member, and the sealing member is arranged around the groove opening of the battery cell accommodating groove and clamped between the cabinet body and the cabinet cover plate;
and/or, one end or both ends of the locking shaft are respectively connected with the cabinet body or the cabinet cover plate that is adjacent;
preferably, the number of the locking shafts is multiple, and a plurality of the locking shafts are arranged along a length direction of the vehicle body longitudinal beam.

5. The battery pack for an electric vehicle according to claim 4, wherein, a fixing block is arranged in the clearance, and the both ends of the locking shaft are connected with the fixing block, and the fixing block is connected with the cabinet body or cabinet cover plate that is adjacent.

6. The battery pack for an electric vehicle according to claim 5, wherein, the accommodating cavities that are adjacent are connected by a clearance connecting structure and form the clearance;
the clearance connecting structure comprises:
a cover plate, the fixing block is connected with the cabinet body of the accommodating cabinet that is adjacent by means of the cover plate;
preferably, a locking aperture is arranged on the cover plate at the position corresponding to the locking mechanism, and the locking shaft is located below the locking aperture.

7. The battery pack for an electric vehicle according to claim 6, wherein, the clearance connecting structure further comprises a pair of C-shaped connecting plates, the C-shaped connecting plate extends along the length direction of the vehicle body longitudinal beam, and the opening direction of the pair of C-shaped connecting plates is arranged opposite to each other, and the fixing block is clamped in the C-shaped connecting plates on the corresponding side;
preferably, the clearance connecting structure further comprises a first supporting plate, and the first supporting plate is arranged between a pair of C-shaped connecting plates, and both ends of the first supporting plate along the width direction of the vehicle body longitudinal beam are respectively connected with a pair of the C-shaped connecting plates;
preferably, the clearance connecting structure further comprises a second supporting plate, the second supporting plate is arranged below the C-shaped connecting plates and is respectively connected with the first supporting plate and the cover plate.

8. The battery pack for an electric vehicle according to claim 3, wherein, the battery pack for an electric vehicle further comprises an ejector rod mechanism for unlocking the locking mechanism, and the ejector rod mechanism is arranged in the clearance, and the ejector rod mechanism comprises an ejector rod, and the ejector rod is vertically arranged and movable along the vertical direction.

9. The battery pack for an electric vehicle according to claim 8, wherein, the battery pack for an electric vehicle further comprises a connecting bottom plate, and the connecting bottom plate is arranged in the clearance, and both ends of the connecting bottom plate are respectively connected to the two cabinet bodies;
the ejector rod mechanism further comprises a guiding base, and a guiding aperture is arranged on the guiding base, and the ejector rod is penetrated through the guiding aperture.

10. The battery pack for an electric vehicle according to claim 9, wherein, the ejector rod mechanism further comprises a first elastic member, and a limiting part is arranged on the ejector rod, and both ends of the first elastic member are respectively connected with the guiding base and the limiting part, and the first elastic member is adopted for exerting an action force to make the ejector rod move downward to the limiting part;
preferably, the first elastic member is sleeved on the ejector rod.

11. The battery pack for an electric vehicle according to claim 9, wherein, the ejector rod mechanism further comprises:
an ejector base, the ejector base is movably arranged on the connecting bottom plate, and an end of the ejector base close to the ejector rod is provided with a transition groove, and a groove depth direction of the transition groove is vertical, and an end of the ejector rod close to the connecting bottom plate extends into the transition groove and can move in the transition groove along the groove depth direction of the transition groove;
a second elastic member, the ejector base is connected with the ejector rod by means of the second elastic member;
preferably, a first stair is arranged on the ejector rod, and the second elastic member is sleeved on the ejector rod, and a first end of the second elastic member abuts on the first stair and a second end of the second elastic member abuts on the ejector base.

12. The battery pack for an electric vehicle according to claim 9, wherein, the guiding base is provided with a first limiting aperture, the first limiting aperture is coaxially arranged with the guiding aperture, and a second stair is arranged on the ejector rod, and the ejector rod is penetrated into the first limiting aperture;
the second stair of the ejector rod abuts against the first limiting aperture when the ejector rod mechanism is in an initial state.

13. The battery pack for an electric vehicle according to claim 11, wherein, the guiding base is provided with a second limiting aperture, and a third stair is arranged on the ejector base, and the ejector base is penetrated into the second limiting aperture;
when the ejector rod mechanism is in an initial state, the third stair of the ejector base abuts against the second limiting aperture;
preferably, the part of the ejector base which is below the third stair of the ejector base is provided with a limiting member;
when the ejector rod mechanism is in a limit state, the limiting member abuts against the guiding base.

14. The battery pack for an electric vehicle according to claim 9, wherein, at least a pair of positioning apertures are arranged on the connecting bottom plate, and the positioning apertures are adopted for matching with the positioning pins on the battery swapping device;
preferably, the sectional shape of the positioning aperture is rectangular, and length directions of the two positioning apertures are different;
and/or, the positioning apertures are distributed on both sides of the ejector rod along the length direction of the vehicle body longitudinal beam.

15. The battery pack for an electric vehicle according to claim 9, wherein, the connecting bottom plate is provided with a lightening aperture.

16. The battery pack for an electric vehicle according to claim 3, wherein, the battery pack for an electric vehicle further comprises a second electrical connector for docking with the first electrical connector on the vehicle body longitudinal beam, and the second electrical connector is arranged at the position on the cabinet corresponding to the first electrical connector, and the second electrical connector is electrically connected with the battery module;
preferably, the cabinet body further comprises:
a conduit, the conduit is arranged in the clearance and the battery cell accommodating grooves of the accommodating cabinets that are adjacent are communicated by means of the conduit.

17. The battery pack for an electric vehicle according to claim 1, wherein, the number of the accommodating cabinets is three, and the three accommodating cabinets are arranged at intervals to form two clearances, and the locking matching mechanism is arranged in two clearances.

18. An electric vehicle, wherein, the electric vehicle comprises a vehicle body longitudinal beam and a battery pack for an electric vehicle according to claim 1, and a locking mechanism is arranged on the vehicle body longitudinal beam, and the battery pack for an electric vehicle is detachably connected to the vehicle body longitudinal beam by matching the locking matching mechanism with the locking mechanism.

19. The electric vehicle according to claim 18, wherein, the electric vehicle further comprises a vehicle body bracket, and the vehicle body bracket is arranged on the vehicle body longitudinal beam, and the locking mechanism is arranged on the vehicle body bracket;
and/or, the locking mating mechanism comprises a locking shaft arranged horizontally, and the locking shaft extends along the width direction of the vehicle body longitudinal beam, and the locking mechanism comprises a through groove, through which the locking shaft penetrates.

20. The electric vehicle according to claim 19, wherein, the top of the battery pack for an electric vehicle is located below the vehicle body bracket or the vehicle body longitudinal beam.
